(19) United States
(12) Patent Application Publication
(10) Pub. No.: US 2026/0319115 A1
(43) Pub. Date: Oct. 15, 2026

(54) An autonomous geophysical recording device with an oscillator clock for seismic use

(71) Applicant: PXGEO NORWAY AS, OSLO (NO)

(72) Inventors: Asgeir SUNNANAA, BEKKESTUA (NO); Ulf RALBERG, Värmdö (SE)

(21) Appl. No.: 19/099,919

(22) PCT Filed: Nov. 11, 2024
(86) PCT No.: PCT/NO2024/050245

§ 371 Date: Jan. 30, 2025

(30) Foreign Application Priority Data
Dec. 1, 2023 (NO) 20231311

(51) Int. Cl. G01V 1/16

(52) U.S. Cl. CPC G01V 1/162; G01V 2200/12

(57) ABSTRACT

An autonomous geophysical recording device 10 is provided, featuring a robust metallic casing capable of withstanding high pressures and deep-sea deployment. The autonomous geophysical recording device 10 comprises a pressure casing 12, a sensor electronic board 24, one or more geophysical sensors 26, one or more auxiliary sensors 28, an analog to digital recording electronic unit, a memory, and an oscillator clock 14 equipped with a first oscillator 16 and a second oscillator 18. The oscillator clock 14 is designed to ensure precise timing for data collection from the geophysical sensor 26 and the auxiliary sensor 28, functioning in either a normal mode or a low power (LP) mode. Notably, the first oscillator 16 is permanently attached to the pressure casing 12 using a heat conducting member 22, effectively regulating temperature. This approach minimizes potential temperature gradients occurring during each cycle between disciplining events, thereby ensuring consistent and enhanced performance.

### TECHNICAL FIELD

The present invention relates to the field of marine seismic exploration. More particularly, the invention relates to an autonomous geophysical recording device comprising an oscillator clock that ensures lower power consumption and reduces component redundancy, thereby lower the costs and reduced overall power consumption.

### BACKGROUND ART

Marine seismic exploration systems and methods typically utilize a seismic energy source to create an acoustic signal that travels into the earth and is partially reflected and/or refracted by interfaces and inhomogeneities in the subsurface. These reflected and refracted signals, known as “seismic data,” are detected and recorded by seismic receivers positioned at or near the earth's surface, thereby generating a seismic survey of the subsurface. The recorded signals, or seismic energy data, can then be processed to provide information about the subsurface formations.

Two main techniques are generally employed for recording the seismic data. One involves deploying hydrophones mounted in streamers and towed behind a vessel, while the other involves collecting seismic signals at the ocean bottom using autonomous seismic nodes containing both hydrophones and geophones.

In recent times, efforts have intensified to enhance marine seismic investigations by collecting seismic data at the ocean bottom. Autonomous seismic nodes are deployed in the ocean depths through the use of a remotely operated vehicle or by simply dropping the seismic nodes into the water to record autonomous seismic data. Another approach involves deploying the autonomous seismic nodes with a flexible rope to the ocean bottom, with the nodes subsequently being recovered by winching up the rope.

With the existing methods, a vessel must deploy the seismic nodes, and after the seismic data is recorded, retrieve the nodes for further use. Optimal scheduling of these activities may be challenging in variable marine environments and under different weather conditions. During a typical data acquisition program, the seismic nodes are submerged for extended periods, which could span several days, weeks, or even months. During this deployment, oscillators in the seismic nodes may experience drift, resulting in time errors in the sampled seismic data due to factors such as aging, temperature changes or gravitational forces.

Moreover, the autonomous seismic nodes must operate for these prolonged periods without additional battery charging, necessitating the nodes to be highly power-efficient. Precision in the recording of seismic nodes and their components is critical during offshore oil or gas exploration. Inaccuracies in the seismic nodes or their parts could lead to inaccurate mapping of available hydrocarbon and gas resources.

One of the key factors influencing recording precision is drift, which refers to the rate at which an oscillator of the seismic node gains or loses frequency in relation to a specified frequency. All oscillators experience frequency changes, albeit at different rates. Drift in an oscillator causes changes in the oscillator's frequency, leading to timing errors in the data. The frequency accuracy and stability of an oscillator play a critical role in ensuring reliable data recording.

Temperature coefficient is a critical factor affecting drift and recording precision. It determines how much an oscillator's frequency changes in response to alterations in temperature. Temperature fluctuations can significantly impact the frequency of an oscillator, leading to inaccuracies in the recorded data.

In addition to temperature-induced drift, oscillators may be affected by other environmental variations caused by vibrations, gravity, power supply fluctuations, and other factors. Crystal aging is yet another aspect that can influence the output frequency of oscillators, with a variety of electromechanical mechanisms contributing to the aging process.

Temperature Compensated Crystal Oscillator (TCXO) is a type of crystal oscillator that incorporates a temperature-sensitive reactance circuit within its oscillation loop, designed to counteract the frequency-temperature characteristics intrinsic to the crystal unit.

The Chip Scale Atomic Clock (CSAC), commercially launched by Symmetricom in 2011, operates in two modes: normal mode and Ultra Low Power (ULP) Mode. In normal mode, the physics package, in combination with the frequency logic portion, generates a highly stable frequency, which is then used to regulate a Temperature Compensated Crystal Oscillator (TCXO) that provides the output clock signal from the Chip Scale Atomic Clock (CSAC). But in Ultra Low Power (ULP) mode, the physics package and the frequency control logic portion are periodically turned off, allowing the Temperature Compensated Crystal Oscillator (TCXO) to function independently.

However, the Ultra-Low Power (ULP) Mode performance of the Chip Scale Atomic Clock (CSAC) was relatively unstable. The frequency drift was affected by the use of a low-quality Temperature Compensated Crystal Oscillator (TCXO), which was susceptible to aging and temperature variations within the clock. These temperature variations were induced by the heat generated each time the physics package and associated electronics were activated. Additionally, the Temperature Compensated Crystal Oscillator (TCXO) used was also sensitive to gravity effects. Consequently, the Ultra-Low Power (ULP) Mode exhibited significantly reduced performance. Moreover, the physics package had to be heated up and operated for 5-10 minutes to achieve sufficient stability of its frequency output, thereby affecting the overall power consumption.

U.S. Pat. No. 11,402,526 discloses a seismic spread system employing MEMS (Microelectromechanical Systems) oscillators as timing references. The system consists of multiple nodal seismic sensor units and corresponding MEMS oscillator clock devices. Each MEMS oscillator clock device is associated with one of the nodal seismic sensor units, enabling time synchronization within the seismic system and data collection. These MEMS oscillator clock devices feature MEMS resonators communicating with integrated circuits.

U.S. Pat. No. 9,417,359 discloses a seismic node device with a primary oscillator and a reference oscillator, controlled by a processor for frequency calibration of the primary oscillator using a calibration value derived from the reference oscillator's frequency. The reference oscillator is an atomic clock or an oven-controlled crystal oscillator (OCXO). The reference oscillator may generate the same output frequency as the primary oscillator, which could be a temperature-compensated crystal oscillator (TCXO) or any high-quality oscillator. While atomic clock or OCXO is more stable, it consume more power than a TCXO. In this patent, the primary oscillator is placed outside the reference oscillator and is frequently corrected or calibrated using the reference oscillator's frequency. The primary oscillator may exhibit substantial frequency drift over time that can significantly impact the quality of the clock signal and, consequently, the recorded data in the low-power (LP).

The demand for reduced battery power consumption and efficient handling of frequency drift presents substantial obstacles for the operations of most seismic node systems, constraining their application to areas where cable surveys are not viable due to operational constraints, such as in the vicinity of platforms or in deep water. The complexities associated with seismic nodes have made their operation challenging, thus necessitating the development of an oscillator clock that addresses these issues effectively while ensuring lower power consumption and reduced component redundancy, thereby lowering costs and reduced overall power consumption.

### SUMMARY OF THE INVENTION

Aspects of the present invention provide an autonomous geophysical recording device designed with a thick metallic casing capable of withstanding high pressures and deep-sea deployment. The autonomous geophysical sensor node incorporates an oscillator clock, enabling stable frequency output at a reduced power consumption rate.

In one aspect the invention provides an autonomous geophysical recording device for use in underwater environment, the autonomous geophysical recording device comprises a pressure casing, a sensor electronic board, at least one geophysical sensor, at least one auxiliary sensor, an analog to digital recording electronic unit, a memory, and an oscillator clock comprising a first oscillator and a second oscillator. The oscillator clock is specifically configured to provide precise timing for data collection from the geophysical sensor and the auxiliary sensor, and it operates in either a normal mode or a low power (LP) mode.

In one aspect of the invention, the first oscillator is a Voltage Controlled, Temperature Compensated Crystal Oscillator (VCTCXO), and the second oscillator is a SiT5503 precision oscillator.

In one aspect of the invention, the first oscillator of the oscillator clock is permanently affixed to the pressure casing using a heat conducting member, ensuring that temperature regulation is effectively managed. Consequently, any potential temperature gradient occurring during each cycle between disciplining events is minimized, thus guaranteeing consistent and reliable performance.

Moreover, the second oscillator is programmed to enter a standby mode during the intervals between each disciplining event of the first oscillator.

In addition, the autonomous geophysical recording device records the difference in frequency between the first oscillator and the second oscillator after each disciplining event, storing this data in the memory and using it as input in the subsequent disciplining event.

In another aspect of the invention, the oscillator clock is equipped with a frequency controller, which generates reference voltages, said frequency controller can be integrated and/or shared with the analog to digital recording electronic unit.

Another aspect of the invention facilitates the transmission of signals from the oscillator clock to the sensor electronic board for the digitization and storage of analog signals received from the geophysical sensor and the auxiliary sensor.

Additionally, the oscillator clock further incorporates a heat isolation member that effectively thermally isolates a section of the oscillator clock from heat-generating electronic components.

Advantages of the present invention are enhanced stability in low power mode, reduced power consumption through efficient integration, improved accuracy in frequency calibration, Cost-effective manufacturing through integration of components and applicability to various system configurations and computing environments

Further details and specification of the invention are described in the detailed description and accompanying figures, providing comprehensive insights into the operation and functionalities of the autonomous geophysical sensor node with enhanced oscillator stability and reduced power consumption.

It is to be understood that the embodiments disclosed herein are exemplary and not exhaustive, and the scope of the invention is defined by the appended claims and their equivalents.

### BRIEF DESCRIPTION OF THE DRAWING

The detailed description will be better understood in conjunction with the accompanying drawings as follows:

FIG. 1 is a schematic view of an autonomous geophysical sensor node according to an embodiment of the present invention;

FIG. 2 is a schematic view of an autonomous geophysical sensor node according to another embodiment of the present invention;

FIG. 3 is a schematic view of an autonomous geophysical sensor node according to another embodiment of the present invention; and

FIG. 4 is a schematic view of an autonomous geophysical sensor node according to another embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiments set forth herein. Rather, the embodiments are provided so that this disclosure will be thorough, and will fully convey the scope of the invention to those skilled in the art.

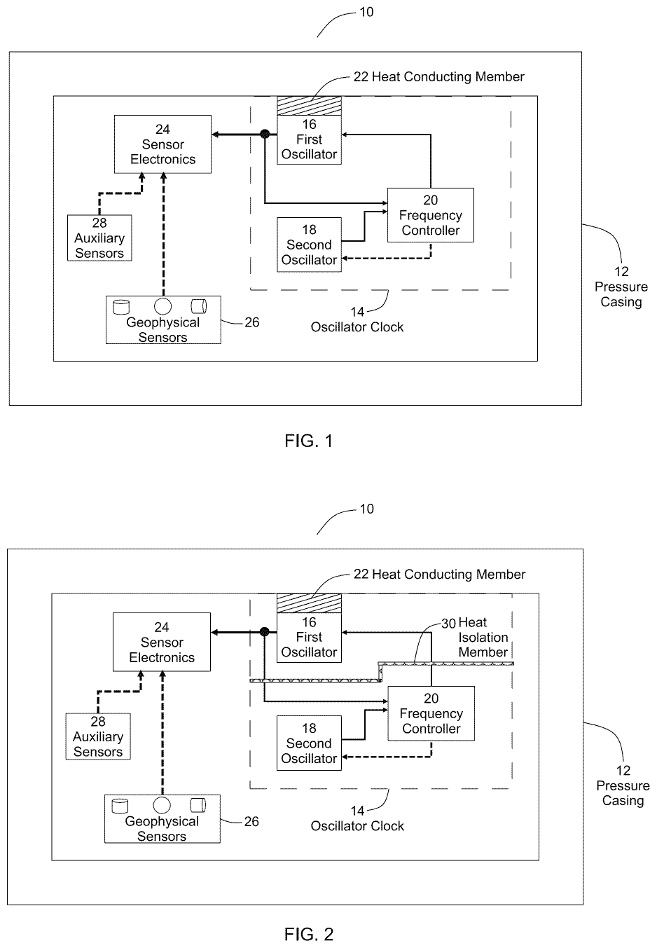

Embodiments of the present invention, as depicted in FIG. 1, are schematic views of an autonomous geophysical sensor node 10 designed in a thick metallic casing 12. The casing 12 is a pressure casing capable of withstanding a pressure range of 300 to 400 Bar and is rated for deployment down to 3000-4000 m water depth.

As shown in FIG. 1, the autonomous geophysical sensor node 10 comprises an oscillator clock 14, sensor electronics 24, one or more geophysical sensors 26, and one or more auxiliary sensors 28, all packaged inside the casing 12. The oscillator clock 14 contains various components, the details of which are described herein, including the functionalities of the oscillator clock 14 and the problems addressed by the invention.

In one embodiment, the oscillator clock 14 includes a first oscillator 16 and a second oscillator 18 connected to a frequency controller 20, where the first oscillator 16 is a Voltage Controlled, Temperature Compensated Crystal Oscillator (VCTCXO) or a temperature compensated crystal oscillator (TCXO) and the second oscillator 18 is a SiT5503 precision oscillator.

In one embodiment, the output from the oscillator clock 14 is provided by the first oscillator 16, generating a frequency of 16.384 MHz. Subsequently, the clock signal from the oscillator clock 14 is fed to the Sensor Electronics 24, responsible for digitizing and storing the analog signals derived from the sensor electronics 24 and the geophysical sensors 26.

Furthermore, the autonomous geophysical sensor node 10 includes a memory intended for storing data, such as digitally recorded seismic data generated from the geophysical sensors 26 and the auxiliary sensors 28. The memory may encompass random access memory (RAM) with instructions and any type of physical memory, including read-only memory (ROM) containing a basic input/output system (BIOS) with fundamental routines facilitating information/data transfer between elements within the autonomous geophysical sensor node 10.

According to the invention, in a normal operation the first oscillator 16 is continuously compared and adjusted to the output frequency from the second oscillator 18 within the oscillator clock 14. The second oscillator 18 is SIT5503 precision oscillator or an oscillator with a similar functionality that improves/enhances the frequency and environmental stability of the first oscillator 16. The majority of the power consumption of the oscillator clock 14 is consumed by the second oscillator 18, the frequency controller 20 and some other associated electronic components. Since it is very important to minimise the power consumption of the nodes, such that they can be deployed and record data for long periods on the sea bottom, the oscillator clock 14 has a low power function (LP mode) that can be selected by the user. In this low power function (LP mode), the second oscillator 18 and the frequency controller 20 is set into a standby mode/low power mode at certain time intervals during which the first oscillator 16 is “free running”. Periodically the first oscillator and the frequency controller 20 of the oscillator clock 14 is powered up from standby mode and the first oscillator 16 is re-calibrated to the output frequency from the second oscillator 18. Operating in this mode the oscillator clock 14 will have the short time stability and characteristics of the first oscillator 16 and the long-time stability of the SiT5503 and this at significantly lower power consumption.

The first oscillator 16 consumes very little power compared to the second oscillator 18, but it experiences a significantly higher frequency drift due to aging effects and is more sensitive to ambient temperature changes and gravity effects. Specifically, the first oscillator 16 is susceptible to temperature changes caused by the heat generated from other electronic components within the oscillator clock 14. This temperature variation induces a frequency drift that can significantly impact the quality of the clock signal and, consequently, the recorded data in the low-power (LP) mode.

In a preferred embodiment, the invention offers a solution to this issue by firmly and permanently attaching the first oscillator 16 to the casing 12 via a heat conducting member 22. The casing 12, made of thick aluminum, and the deployment of the nodes at the sea bottom, surrounded by water, ensures that any temperature gradient is negligible, especially during the short periods when the first oscillator 16 is “free running” in the low-power (LP) mode.

By minimizing the temperature fluctuations that could affect the first oscillator 16, the low-power (LP) mode exhibits improved short-term stability while still maintaining the long-term stability provided by the second oscillator 18. This improvement comes at a significantly lower power consumption, addressing the challenges posed by temperature variations and ensuring the overall reliability of the geophysical sensor node's operation.

According to another embodiment, as illustrated in FIG. 2, incorporates a heat isolation member 30 designed to shield the remaining components of the oscillator clock 14 from heat-generating elements. This heat isolation member 30 effectively protects other vital parts and components, including the second oscillator 18 and the frequency controller 20, ensuring their stable and reliable operation within the system.

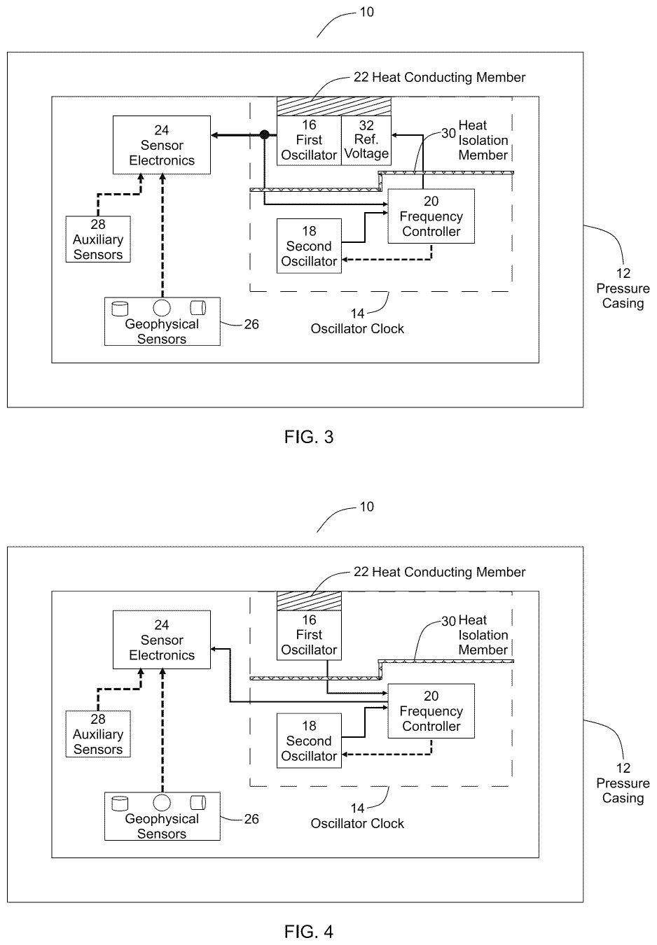

According to another embodiment, as illustrated in FIG. 3, a voltage reference device (Vref) 32 is mounted to the casing 12 in the vicinity to the first oscillator 16 via the heat conducting member 22 and hence reduce the effect of temperature variations affecting the voltage reference device 32 which can further stabilise and improve the frequency output from the first oscillator 16.

The described embodiments resolve the issue concerning frequency stability when operating in Low Power (LP) mode by permanently attaching the first oscillator 16 to the casing 12 (pressure casing) of the autonomous geophysical sensor node 10 via a heat conducting member 22. This approach effectively minimizes any temperature gradient during each cycle in between disciplining events, ensuring a consistent and reliable performance. The choice of aluminium for the pressure casing 12, along with the node's deployment at the sea bed surrounded by water, facilitates the efficient functioning of this arrangement.

Furthermore, the SiT5503-based second oscillator 18 integrated within the oscillator clock 14 exhibits a very short start-up time, ensuring a stable frequency output. This attribute contributes significantly to the reduction of power consumption, enhancing the overall efficiency and performance of the geophysical sensor node under varying operational conditions.

In a specific embodiment, certain electronic components of the oscillator clock 14, including the frequency controller 20 and other associated logic programming for generating a reference frequency, can be moved, integrated and shared with the sensor electronics 24 responsible for analog-to-digital recording on the main circuit board. By minimizing the duplication of components within the autonomous geophysical sensor node 10, manufacturing costs are reduced, and overall power consumption is lowered.

The autonomous geophysical sensor node 10 is equipped with a dedicated analog-to-digital recording unit and a related computing environment for frequency calibration, ensuring accurate and efficient data processing and recording capabilities.

In another embodiment, the oscillator clock 14 can be run in normal mode during the deployment to the sea floor and after a time when the node 10 has reached a stable position on the sea floor and the aluminium casing 12 has reached a constant and stable temperature equivalent to the surrounding sea water, the second oscillator 18 is turned off permanently such that the clock signal is only derived from the first oscillator 16 for the remaining time of the deployment and thus an even lower overall power consumption will be achieved.

In another embodiment, the oscillator clock 14 can be run in a parallel mode where oscillator 16 and second oscillator 18 are separately run, each generating a frequency that is stored in memory during the deployment to the sea floor, and after a time when the node has reached a stable position on the sea floor and the aluminium casing 12 has reached a constant and stable temperature equivalent to the surrounding sea water, the first oscillator 16 is disciplined by second oscillator 18 and then the second oscillator 18 is turned off permanently such that the clock signal is only derived from the first oscillator 16 for the remaining time of the deployment and thus an even lower overall power consumption will be achieved.

In in another embodiment, first oscillator 16 will continuously provide the clock signal to the analog-to-digital recording unit and the second oscillator 18 will be in standby mode or turned off. An auxiliary sensor 28 measuring acceleration can provide acceleration data and based on if any acceleration forces are reaching above a defined threshold value, then the second oscillator 18 will be started and continuously discipline first oscillator 16 until the acceleration data is again below the defined threshold.

In an alternate embodiment, as illustrated in FIG. 4, the first oscillator 16 in the oscillator clock 14 can consist of a XO oscillator (quartz crystal oscillator) which will continuously provide a frequency to the frequency controller 20 which can be a field-programmable gate array (FPGA), where said frequency is compared with the frequency generated by the second oscillator 18, and where a third frequency is digitally constructed and subsequently fed into the analog-to-digital recording unit. In this embodiment the first frequency generated by the first oscillator has to be at least a factor of two above compared to the desired third frequency of the clock signal output from the frequency controller (FPGA).

Furthermore, in another embodiment, all electronic components that constitute the oscillator clock 14, excluding the first oscillator 16, can be integrated onto the main circuit board and shared with the sensor electronics 24 for analog-to-digital recording. This integration streamlines the manufacturing process of the autonomous geophysical sensor node 10 by reducing the number of components and circuit boards required, resulting in a significant cost reduction and low overall power consumption.

The invention also introduces a novel software-based method for re-disciplining the first oscillator 16 within the oscillator clock 14, achieved through the implementation of specific logic gates. This innovative approach dramatically shortens the time required for disciplining the first oscillator 16, thereby enhancing both the accuracy and power efficiency of the oscillator clock 14.

These embodiments can be applied in various system configurations, including hand-held devices, multiprocessor systems, microprocessor-based or programmable electronics, network computers, and more. The functionalities of the autonomous geophysical sensor node 10 may be extended to tasks performed in distributed computing environments, where program modules, processors, and operations may be distributed across different memory locations, both locally and remotely.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention without departing from the scope of the invention. The embodiments were chosen and described in order to explain the principles of the invention and its practical application to enable one skilled in the art to utilize the invention in various embodiments and with various modifications as are suited to the particular use contemplated.

1-27. (canceled)

28. An autonomous geophysical recording device (10) for use in underwater environment, comprising:
a pressure casing;
a sensor electronic board;
at least one geophysical sensor;
at least one auxiliary sensor;
an analog to digital recording electronic unit;
a memory; and
an oscillator clock comprising a first oscillator and a second oscillator, where the oscillator clock is configured for providing precise timings of data from the geophysical sensor and the auxiliary sensor, where oscillator clock (14) is operating in either a normal mode or a low power (LP) mode,
wherein the first oscillator of the oscillator clock that is permanently attached to the pressure casing using a heat conducting member for regulating temperature, where any potential temperature gradient occurring during each cycle between disciplining events is minimised.

29. The autonomous geophysical recording device according to claim 28, further comprising a heat isolation member that thermally isolates a part of the oscillator clock from heat generating electronic components.

30. The autonomous geophysical recording device according to claim 28, wherein the second oscillator is programmed to enter a standby mode during the intervals between each disciplining event of the first oscillator.

31. The autonomous geophysical recording device according to claim 28, wherein records the difference in frequency between the first oscillator and second oscillator, stores in the memory after each disciplining event and uses as input in a subsequent disciplining event.

32. The autonomous geophysical recording device according to claim 28, wherein the geophysical sensors are seismic sensors.

33. The autonomous geophysical recording device according to claim 28, wherein the geophysical sensors are electromagnetic sensors.

34. The autonomous geophysical recording device according to claim 28, wherein the first oscillator is a Voltage Controlled, Temperature Compensated Crystal Oscillator (VCTCXO).

35. The autonomous geophysical recording device according to claim 28, wherein the first oscillator is a Crystal Oscillator (XO).

36. The autonomous geophysical recording device according to claim 28, wherein the second oscillator is a SiT5503 precision oscillator.

37. The autonomous geophysical recording device according to claim 28, wherein the pressure casing is made of metallic material.

38. The autonomous geophysical recording device according to claim 28, wherein the oscillator clock further comprises a frequency controller that generates reference voltages, which are integrated and/or shared with the analog to digital recording electronic unit.

39. The autonomous geophysical recording device according to claim 28, wherein facilitates the transmission of signals from the oscillator clock to the sensor electronic board for the digitization and storage of analog signals received from the geophysical sensor and the auxiliary sensor.

40. The autonomous geophysical recording device according to claim 28, wherein a voltage reference device is permanently attached to the pressure casing using the heat conducting member for regulating temperature, where any potential temperature gradient generated from other electronic components is minimised.

41. The autonomous geophysical recording device according to claim 28, wherein the first oscillator will continuously provide a frequency to the frequency controller, where the frequency is compared with a frequency generated by the second oscillator, and whereby a third frequency is digitally generated and fed into the analog-to-digital recording unit and where said first frequency of the first oscillator are at least a factor of two higher than the desired third frequency of the clock signal output from the frequency controller.

42. A method for improving performance of an autonomous geophysical recording device for use in underwater environment, the method comprising:
integrating a sensor electronic board, at least one geophysical sensor, at least one auxiliary sensor, an analog to digital recording electronic unit; a memory, and an oscillator clock in a pressure casing, where the oscillator clock having a first oscillator and a second oscillator, where the oscillator clock is configured for providing precise timings of data from the geophysical sensor and the auxiliary sensor, where oscillator clock is operating in either a normal mode or a low power (LP) mode,
wherein the first oscillator that is permanently attached to the pressure casing using a heat conducting member for regulating temperature, where any potential temperature gradient occurring during each cycle between disciplining events is minimised.

43. The method according to claim 42, wherein the second oscillator is programmed to enter a standby mode during the intervals between each disciplining event of the first oscillator.

44. The method according to claim 42, wherein records the difference in frequency between the first oscillator and second oscillator, stores in the memory after each disciplining event and uses as input in the subsequent disciplining event.

45. The method according to claim 42, wherein the geophysical sensors are seismic sensors.

46. The method according to claim 42, wherein the geophysical sensors are electromagnetic sensors.

47. The method according to claim 42, wherein the first oscillator is a Voltage Controlled, Temperature Compensated Crystal Oscillator (VCTCXO).

48. The method according to claim 42, wherein the first oscillator is a Crystal Oscillator (XO).

49. The method according to claim 42, wherein the second oscillator is a SiT5503 precision oscillator.

50. The method according to claim 42, wherein the pressure casing is made of metallic material.

51. The method according to claim 42, wherein the oscillator clock further comprises a frequency controller for generating reference voltages that are integrated and/or shared with the analog to digital recording electronic unit.

52. The method according to claim 42, wherein a voltage reference device is permanently attached to the pressure casing using the heat conducting member for regulating temperature, where any potential temperature gradient generated from other electronic components is minimised.

53. The method according to claim 42, wherein the first oscillator will continuously provide a frequency to the frequency controller, where the frequency is compared with the frequency generated by the second oscillator, and where a third frequency is digitally generated and fed into the analog-to-digital recording unit and where said first frequency of the first oscillator are at least a factor of two higher than the desired third frequency of the clock signal output from the frequency controller.

54. An autonomous geophysical recording device for use in underwater environment, comprising:
a pressure casing;
a sensor electronic board;
at least one geophysical sensor;
at least one auxiliary sensor;
an analog to digital recording electronic unit;
a memory; and
an oscillator clock comprising a first oscillator and a second oscillator, where the oscillator clock is configured for providing precise timings of data from the geophysical sensor and the auxiliary sensor, where oscillator clock is operating in either a normal mode or a low power (LP) mode,
wherein the first oscillator of the oscillator clock that is permanently attached to the pressure casing using a heat conducting member for regulating temperature, where any potential temperature gradient occurring during each cycle between disciplining events is minimised, and
wherein the first oscillator will continuously provide a frequency to the frequency controller, where the frequency is compared with the frequency generated by the second oscillator, and where a third frequency is digitally generated and fed into the analog-to-digital recording unit, and where said first frequency of the first oscillator are at least a factor of two higher than the desired third frequency of the clock signal output from the frequency controller.
